(19) United States
(12) Patent Application Publication
(10) Pub. No.: US 2023/0042319 A1
(43) Pub. Date: Feb. 9, 2023

(54) ELECTRICAL MACHINE INCLUDING AXIAL FLUX ROTOR AND CORELESS STATOR

(71) Applicant: Regal Beloit America, Inc., Beloit, WI (US)

(72) Inventor: Subhash Marutirao Brahmavar, Fort Wayne, IN (US)

(21) Appl. No.: 17/396,164

(22) Filed: Aug. 6, 2021

(51) Int. Cl. H02K 1/27; H02K 5/04; H02K 3/18

(52) U.S. Cl. CPC H02K 1/2713; H02K 5/04; H02K 3/18

(57) ABSTRACT

An axial flux motor includes a housing and a rotor assembly rotatably secured to the housing. The rotor assembly includes a body having first and second opposed faces and defining an axis of rotation and plurality of rotor poles including a first rotor pole and a second rotor pole. The first rotor pole and the second rotor pole cooperatively define an axially extending pocket circumferentially therebetween. The rotor assembly further includes a plurality of spaced apart magnets extending from the first face, a first magnet of the plurality of magnets being positioned within the axially extending pocket. The axial flux motor further includes a coreless stator assembly fixedly secured to the housing, the coreless stator assembly including a supporting platform and a plurality of coils attached on the supporting platform.

### BACKGROUND

The field of the disclosure relates generally to electrical machines, and more particularly, to axial flux electric motors having an axially imbedded permanent magnet rotor and a coreless stator.

One of many applications for an electric motor is to propel fluids, for example to blow air with a fan or blower, as in heating or cooling, and, for example, for pumping a liquid, such as water, to recirculate water in a pool or spa. The electric motor may be configured to rotate an impeller within a pump or blower, which displaces a fluid, causing a fluid flow. Many gas burning appliances include an electric motor, for example, water heaters, boilers, pool heaters, space heaters, furnaces, and radiant heaters. In some examples, the electric motor powers a blower that moves air or a fuel/air mixture through the appliance. In other examples, the electric motor powers a blower that distributes air output from the appliance.

A common motor used in such systems is an alternating current (AC) induction motor. Typically, the AC induction motor is a radial flux motor, where the flux extends radially from the axis of rotation. Another type of motor that may be used in the application described above is an electronically commutated motor (ECM). ECMs may include, but are not limited to, brushless direct current (BLDC) motors, permanent magnet alternating current (PMAC) motors, and variable reluctance motors. Typically, these motors provide higher electrical efficiency than an AC induction motor. Some ECMs have an axial flux configuration in which the flux in the air gap extends in a direction parallel to the axis of rotation of the rotor.

Typically, such ECM motors include a stator core holding electrical windings that is formed of a magnetic material to carry the flux flow. For example, steel is commonly used to form such rotor cores. However, such steel cores may generate resistance to the flux flow during operation, resulting in reduced motor efficiency. Such efficiency losses resulting from resistance to the flux flow through the stator core are commonly referred to as “core loss.” To reduce or minimize core loss, some motors include a coreless stator, such as a printed circuit board (“PCB”) stator, that is not formed of a magnetic material. While such stators may reduce or eliminate efficiency losses due to core loss, coreless stators generally provide inefficient flux transmission with the rotor, thereby reducing the overall motor efficiency.

Some coreless ECM motors may utilize high energy rare earth magnets, such as neodymium magnets for example, to compensate for the reduction in flux transmission caused by the coreless stator. While such magnets may improve motor efficiency, these magnets are often very expensive and are obtainable from only very limited locations. Obtaining improved motor efficiency in a motor having a coreless stator without the need for rare earth magnets is desired.

### BRIEF DESCRIPTION

In one embodiment, an axial flux motor is provided. The axial flux motor includes a housing and a rotor assembly rotatably secured to the housing. The rotor assembly includes a body defining an axis of rotation thereof, the body having first and second opposed faces, a plurality of rotor poles including a first rotor pole and a second rotor pole. The first rotor pole and the second rotor pole cooperatively defining an axially extending pocket circumferentially therebetween. The rotor assembly further includes a plurality of spaced apart magnets extending from the first face, a first magnet of the plurality of magnets being positioned within the axially extending pocket. The axial flux motor further includes a coreless stator assembly fixedly secured to the housing, the coreless stator assembly including a supporting platform and a plurality of coils attached on the supporting platform.

In another embodiment, an axial flux motor is provided. The axial flux motor includes a housing and a rotor rotatably secured to the housing. The rotor includes a body defining an axis of rotation thereof, the body having first and second opposed faces. The rotor further includes a plurality of rotor poles including a first rotor pole and a second rotor pole. The axial flux motor further includes a plurality of spaced apart magnets extending from the first face. A first magnet of the plurality of magnets being positioned circumferentially between, and in contact with, the first rotor pole and the second rotor pole. The axial flux motor further includes a stator fixedly secured to the housing. The stator including a supporting platform formed of a non-magnetic material and a plurality of coils attached on the supporting platform.

In yet another embodiment, an axial flux motor is provided. The axial flux motor includes a housing and a rotor assembly rotatably secured to the housing. The rotor assembly includes a body defining an axis of rotation thereof, the body having first and second opposed faces. The rotor assembly further includes a plurality of rotor poles including a first rotor pole and a second rotor pole. The axial flux motor further includes a plurality of spaced apart magnets extending from the first face. A first magnet of the plurality of magnets is positioned circumferentially between the first rotor pole and the second rotor pole. The axial flux motor further includes a coreless stator assembly fixedly secured to the housing. The coreless stator assembly includes a supporting platform defining a mounting aperture and a bobbin assembly including an electrical winding and a bobbin holding the electrical winding. The bobbin assembly further includes a mounting post extending from the bobbin into the mounting aperture to secure the bobbin assembly to the supporting platform.

### BRIEF DESCRIPTION OF THE DRAWINGS

FIG. 1 is a cross-sectional schematic view of an example electric machine;

FIG. 2 is an exploded schematic view of the electric machine shown in FIG. 1;

FIG. 3 is a front perspective view of a rotor assembly for use in the electric machine shown in FIGS. 1 and 2;

FIG. 4 is a rear perspective view of the rotor assembly shown in FIG. 3;

FIG. 5 is an enlarged view of a portion of the rotor assembly shown in FIGS. 3 and 4;

FIG. 6 is an exploded view of a stator assembly for use in the electric machine shown in FIGS. 1 and 2;

FIG. 7 is an enlarged view of a portion of another embodiment of a rotor assembly for use in the electric machine of FIGS. 1 and 2;

FIG. 8 is a perspective view of another embodiment of a stator assembly for use in the electric machine of FIGS. 1 and 2; and

FIG. 9 is a plan view of yet another embodiment of a stator assembly for use in the electric machine of FIGS. 1 and 2.

### DETAILED DESCRIPTION

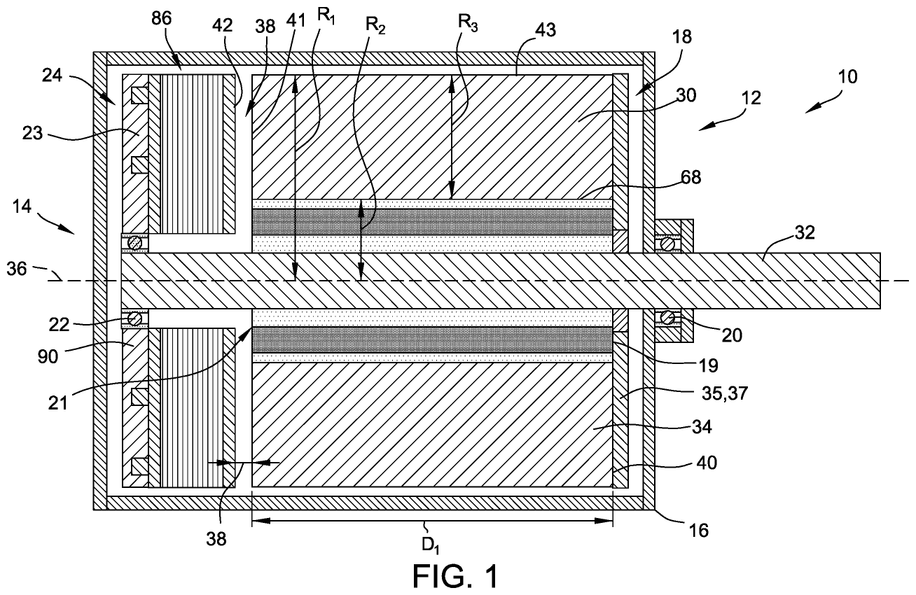

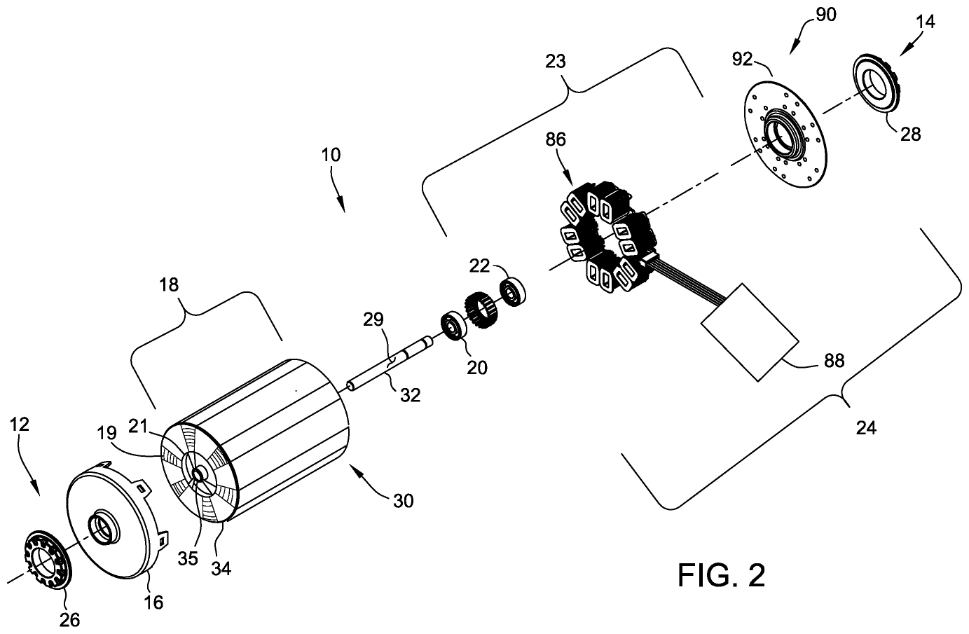

FIG. 1 is a cross-sectional schematic view of an example electric machine 10. FIG. 2 is an exploded schematic view of electric machine 10. Components common to FIGS. 1 and 2 are identified with the same reference numerals. In the example embodiment, electric machine 10 is an electric axial flux motor having a first end 12 and a second end 14. Alternatively, electric machine 10 may operate as an electric generator. Electric machine 10 may generally include a housing 16, a rotor assembly 18, a first bearing assembly 20, a second bearing assembly 22, and a stator assembly 24. A first end mount 26 is coupled to housing 16 at machine first end 12 and a second end mount 28 is coupled to stator assembly 24 at machine second end 14. The stator assembly 24 includes a stator 23 fixedly secured to the housing 16. The rotor assembly 18 is rotatably secured to the housing 16. The rotor assembly 18 may include a body or rotor core 30 that defines an axis of rotation 36 of the body 30. The body 30 has first and second opposed faces or surfaces, 40 and 41, respectively. In the example embodiment, the first and second faces 40, 41 each extend generally perpendicular to the axis of rotation 36 of the body. An air gap 38 is formed between rotor second outer face or surface 41 and a stator outer surface 42, and a magnetic flux within machine 10 extends between permanent magnets 34 and stator assembly 24 in a direction parallel to axis 36.

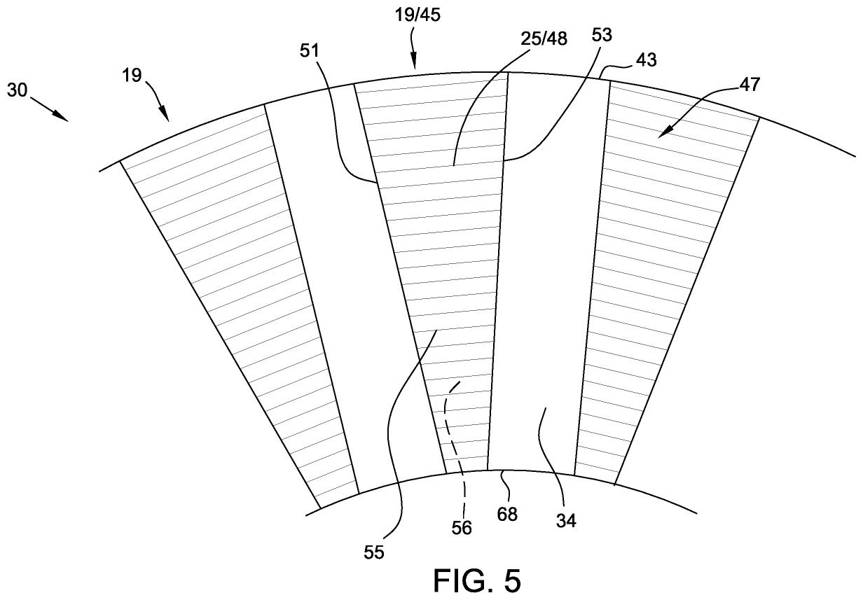

As shown in FIGS. 1-4, the axial flux machine 10 may be provided wherein the rotor or rotor core 30 is substantially cylindrical and includes a plurality of rotor poles 19. The rotor poles 19 include a plurality of laminations 48 (FIG. 5) that are either interlocked or loose. For example, laminations 48 are fabricated from multiple punched layers of stamped metal such as steel. The rotor core 30 includes outer periphery 43 and a shaft central opening 21 having a diameter corresponding to the diameter of shaft 32. The rotor assembly 18 may include the rotor core 30 coupled to shaft 32, and a plurality of permanent magnets 34 may be coupled to rotor 30. It should be appreciated that the radially extending magnets 34 described hereinafter have the advantage of enhanced magnetic flux for a given magnetic material mass. In the example embodiment, the rotor assembly 18 is substantially similar to the rotor assembly 18 described in U.S. Pat. No. 10,951,098, except as described differently below. U.S. Pat. No. 10,951,098 is assigned to the same entity as the instant application and is hereby incorporated in its entirety by reference.

Rotor assembly 18 is rotatably secured to housing 16, and more specifically, is rotatable within first bearing assembly 20 and second bearing assembly 22 about an axis of rotation 36. It should be appreciated that other support schemes may be possible for supporting the rotating rotor assembly within the housing. For example, a single bearing assembly (not shown) may be used and may be located where the first bearing assembly or where the second bearing assembly is located.

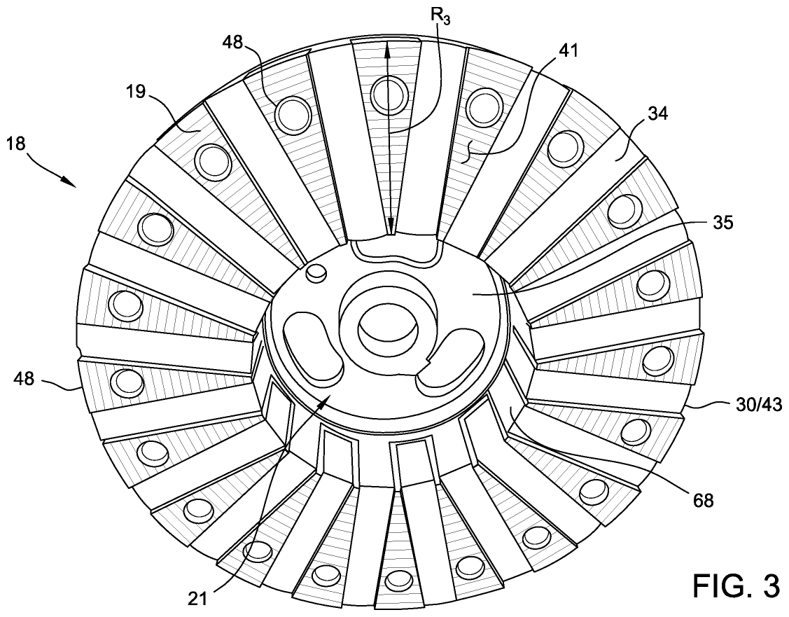

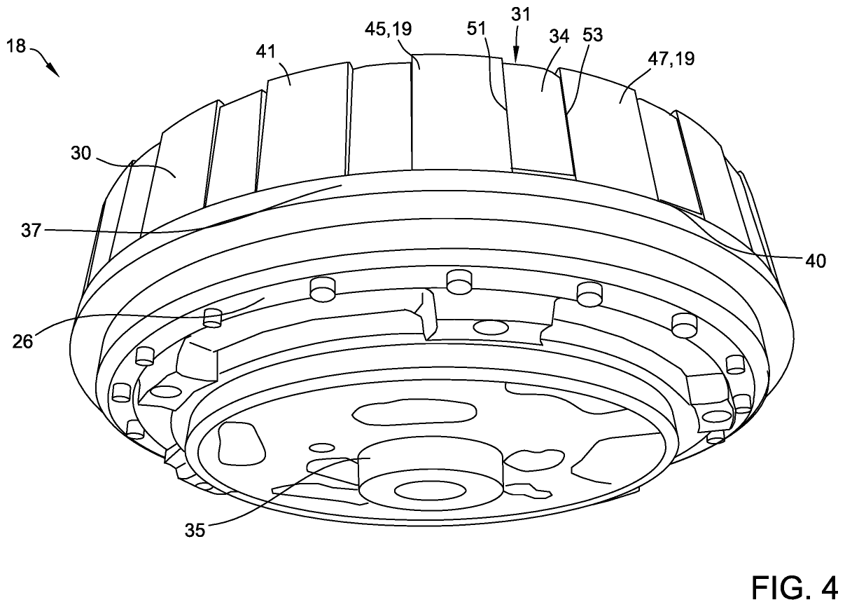

Referring to FIGS. 3 and 4, the body 30 may be made of any suitable material and be manufactured using any available manufacturing process. For example, rotor body 30 may be fabricated using a sintered process from an Soft Magnetic Alloy (SMA), from Soft Magnetic Composite (SMC) materials, and/or from a cast iron material. To minimize eddy current losses the electrical current path along the magnetic flux between poles 19 may be interrupted in a suitable manner. For example the body 30 may be formed of a plurality of sheets or laminations 48. Alternatively, rotor 30 may be fabricated using a sintered process from an SMC material, an SMA material, and/or a cast iron material. Alternatively, rotor 30 is machined and/or cast from any suitable magnetic material that conducts flux. In the example embodiment, rotor assembly 18 is driven by an electronic control (not shown), for example, a sinusoidal or trapezoidal electronic control including control board 88 (see FIG. 2).

The rotor assembly 18 also has a plurality of spaced apart magnets 34. Each of the plurality of magnets 34 is matingly fitted to one of a plurality of pockets 31 (defined between adjacent laminations 48). As shown in FIG. 1, the magnets 34 each extend an axial depth D₁ within the pockets between the laminations between second face 41 of rotor body 30 and hub 37.

While the sheets may form a contiguous core 30 and the magnets 34 may be fitted to the core 30, it should be appreciated that some of the sheets may be combined to form a pole 19 with the sheets of each pole being spaced from the sheets of the other poles. In such a configuration a bonding material, such as a resin may be used to interconnect all the components forming the rotor assembly 18. In such a configuration, the core 30 may include a central portion 21. The central portion 21 may support a central rotor shaft 32 and the poles 19 and the magnets 34 may extend from core outer periphery 43 to the central portion 21 of the core 30.

The rotor assembly 18 may be manufactured by placing the poles 19, the magnets 34 and the shaft 32 in a resin mold (not shown) and injecting resin in to mold, bonding the magnets 34, the shaft 32 and the poles 19 together to form the rotor assembly 18. In such embodiments, the shaft 32 is not placed in the mold and, rather, may be later assembled into the rotor assembly 18

As shown in FIGS. 1-4, rotor core 30 is generally ring shaped and includes a radially outward peripheral ring having an outer wall or surface 43 that has a first or outer radius R₁, defined between the outer surface 43 and the central axis 36. The rotor core 30 further includes a radially inward peripheral surface or inner wall 68 defining the central opening 21. The inner wall 68 has a second or inner radius R₂, defined between the inner wall 68 and the central axis 36. The rotor core 30 has a radial length R₃ defined between the outer wall 43 and the inner wall 68 (i.e., equal to the difference between R₁ and R₂ in the example embodiment). The inner wall 68 may, alternatively, extend to an outer periphery 29 of shaft 32 so that the shaft 32 may support core 30. In another alternative, the inner wall 68 may be spaced from shaft 32 with central portion 21 including for example a sleeve 35 (shown in FIG. 3) engaging the shaft 32 and connected to the inner wall 68.

Referring to FIG. 3, the core 30 extends radially from outer periphery 43 to inner wall 68. The poles 19 are formed from the sheets 48 and are positioned in a spaced apart relationship in the core 30, forming portions of the inner wall 68 and the outer periphery 43. The sheets or laminations 48 are positioned tangentially around the core 30 so that flux lines pass normally across the sheets or laminations 48. The laminations may have any suitable shape. For example, the laminations may extend circumferentially around the central opening 21 of the rotor core 30 and the core 30 may include the pockets or axial apertures 31 (shown in FIG. 4) formed in the laminations 48. For simplicity and as shown in FIG. 3, the laminations 48 consist of separate portions that are spaced circumferentially about the central portion 21 of the rotor core 30. Each portion may form one of the poles or teeth 19 of the rotor core 30.

In the example embodiment, rotor 30 includes a plurality of axial pockets 31. For example, as shown in FIG. 4, a first side 51 and a second side 53 of poles 19 define an axial pocket 31. Each axial pocket 31 extends radially inwardly from rotor core periphery 43 to rotor core inner wall 68 (shown in FIG. 1) and extends axially through rotor 30 from first rotor face 40 to an opposite second rotor outer face or surface 41. Each axial pocket 31 receives one or more permanent magnets 34 such that each magnet is axially embedded in rotor 30 and extends inwardly from rotor outer surface 43 to inner wall or surface 68. In the example embodiment, permanent magnets 34 are substantially rectangular shaped hard ferrite magnets. However, magnets 34 may have any suitable shape and be fabricated from any suitable material that enables machine 10 to function as described herein.

In the example embodiment, the magnets 34 are positioned against the sides 51 and 53 of rotor poles 19. The first and second ends 55 and 56 (shown in FIG. 5) of poles 19 form the first face 40 and the second face 41 (FIG. 1), respectively of the rotor body 30. An external planar face 25 of at least one of the laminations 48 is positioned over the external planar face (not shown) of another of the laminations 48 to form a first rotor pole 45. Additional laminations, for example 3 to 25 laminations, are similarly positioned to form the second rotor pole 47. The first and second rotor poles 45, 47 are spaced apart and secured to a bonding material, such as a molded polymer or a resin. Mechanical interlocks (not shown) may be formed in the laminations 48 and may for example be in the form of protrusions in one lamination that mate with pockets in another lamination. Such interlocks are more fully described in U.S. Pat. No. 6,847,285 B2 that is assigned to the same entity as the instant application and hereby incorporated in its entirety by reference.

In the example embodiment, rotor 30 includes a plurality of rotor poles 19 each having an outer surface along rotor outer periphery 43 and extending radially inwardly to inner wall 68. As shown in FIGS. 4 and 5, the poles 19 have a trapezoidal or pie-shape and the magnets 34 are rectangular or square. It should be appreciated that the magnets 34 may likewise be trapezoidal or pie-shaped with the included angle of the pie-shaped pieces being less if both the magnets and the poles have trapezoidal or pie shapes. The trapezoidal poles 19 include laminations 48 made of progressively increasing lengths. Each lamination 48 in each pole 19 is made of a different length and the laminations are assembled with each lamination being of progressively increasing length. Such a pole 19 may be significantly more expensive to manufacture. In other embodiments the poles 19 may be formed from a plurality of layers wound into a ring shaped rotor core from a unitary ferrous sheet. In such embodiments, the sheet may define notches or pockets and the magnets 34 are positioned in the pockets 31. In the example embodiment, the number of axial pockets 31 is equal to the number of rotor poles 19, and one magnet 34 is positioned within each axial aperture 31 between a pair of rotor poles 19. Rotor 30 may have any number of rotor poles 19 that enables electric machine 10 to function as described herein, for example, six, eight, ten or twelve poles.

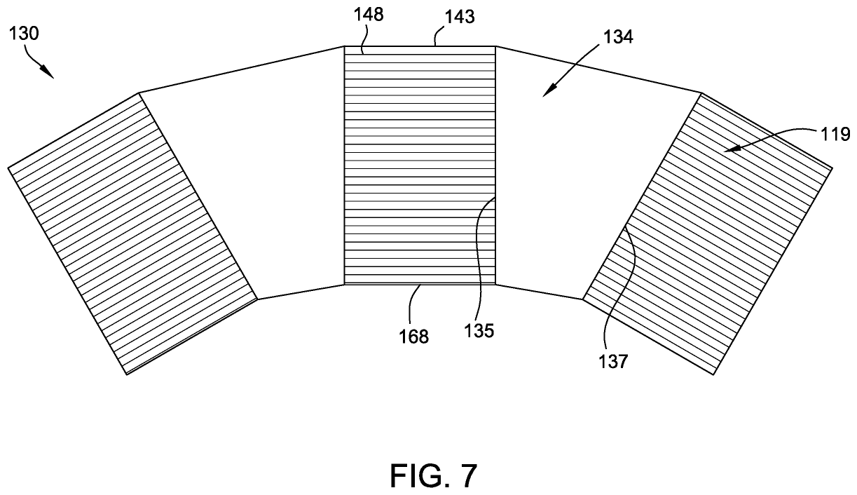

Although illustrated as generally trapezoidal in FIGS. 4 and 5, rotor poles 19 may have any suitable shape that enables machine 10 to function as described herein. For example, some rotor poles 119 may be have a generally rectangular shape, as shown in the rotor assembly 130 of FIG. 7. In such embodiments, the laminations 148 each have a generally constant axial length (i.e., extending into the page in FIG. 7). Moreover, in the embodiment of FIG. 7, magnets 134 each have a trapezoidal shape such that magnets 134 contact adjacent poles 119 along radial edges 135, 137 of the magnets between the inner wall 168 and the outer wall 143.

Referring back to FIG. 4, in the example embodiment, rotor assembly 18 generally includes a sleeve 35 for engagement with shaft 32 (shown in FIG. 1), and a hub 37 positioned between sleeve 35 and rotor poles 19. In the example embodiment, sleeve 35 is fabricated from steel. However, sleeve 35 may be formed from any suitable material that enables rotor 30 to function as described herein. Alternatively, sleeve 35 may be excluded and hub 37 is directly coupled to shaft 32 (e.g., as shown in FIG. 1). In the example embodiment, hub 37 is fabricated from an injection molded polymer. However, hub 37 may be formed from any suitable non-magnetic material that enables rotor 30 to function as described herein. For example, hub 37 may be machined, extruded or die cast non-magnetic material such as aluminum or zinc. Alternatively, hub 37 is fabricated from an isolation damping material configured to reduce transmission of at least one of motor torque pulsations, motor torque ripple, and motor torque cogging.

In the example embodiment, the design of rotor 30 utilizes lower-cost magnets, yet achieves the power densities and high efficiency of machines using higher-cost magnets such as neodymium magnets. In the example embodiment, increased efficiency and power density of machine 10 is obtained by increasing the flux produced by rotor 30. That is, the flux output of rotor 30 is directly proportional to the depth of the magnets 34. The increased flux generation is facilitated by magnets 34 having a minimum depth, which is defined by the equation (1):

[symbol]

=2*N*D₁*R₃*Br (eq. 1);

wherein Φ represents the flux output of rotor 30, N represents the number of rotor poles 19, D₁ represents the axial depth of the magnets 34, R₃ represents the radial length of the magnets 34, and Br represents the remnant flux density of the magnets 34. As a result, for a given and/or desired flux output of the rotor, a minimum axial depth of the magnets 34 may be determined by the equation (2), provided below:

$${D}_{1} = \frac{Φ}{2 * N * {R}_{3} * Br} . \qquad ( eq . 2 )$$

In the example embodiment, rotor 30 facilitates increased flux production resulting in improved efficiency and power density due to an elongated axial depth D₁ of magnets 34. In the example embodiment, depth D₁ may be variably selected to adjust the power output of machine 10 while maintaining a constant rotor size (a constant radial length R₃ and a constant number of poles 19). For example, decreasing depth D₁ lowers motor power output and increasing depth D₁ increases motor output. For example, in the example embodiment, motor power output of axial flux machine 10 is approximately one horsepower and magnets 34 have an axial depth D₁ of approximately one inch. In other embodiments, the size of the rotor 30 may also be adjusted to provide greater horsepower. For example, for larger horsepower motors at least one of the radial length R₃ and the axial depth D₁ of the magnets may be increased. As such, machine 10 may be designed for a specific power output application without additional tooling costs to adjust the outer diameter of the rotor and/or stator.

While the axial flux motor of the present disclosure may be provided with poles that are generally trapezoidal, other shapes are anticipated and may function similarly. The use of rectangular poles (e.g., as shown in FIG. 7) may provide for more simple manufacturing and assembly of rotor poles 19. For rectangular or square poles, each lamination forming the poles may be identical to each other. The laminations may be stamped from a coil of material, for example steel. The laminations may be randomly assembled to form poles, since each lamination may be identical to each other.

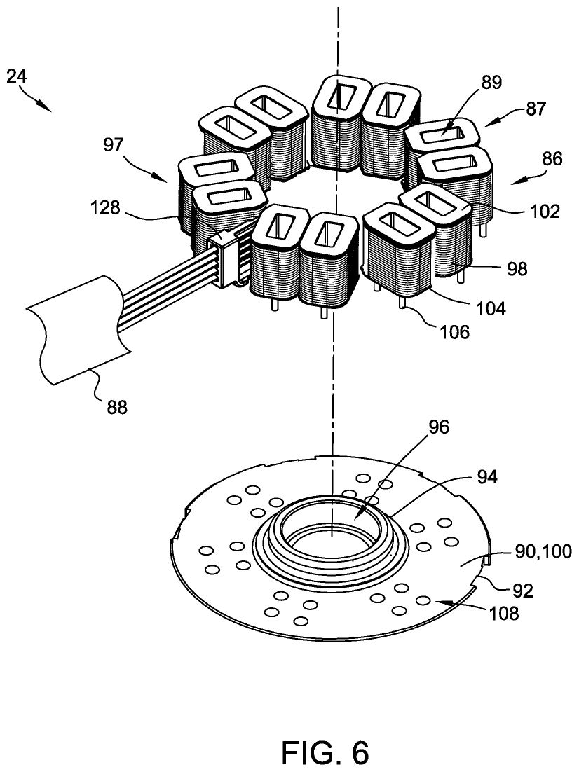

FIG. 6 shows a perspective view of an example stator assembly 24, including bobbin assembly 86 and stator plate 90, more broadly a “supporting platform,” that may be included within electric machine 10, shown in FIG. 1. Bobbin assembly 86 is coupled to stator plate 90 to form a packed stator assembly 24.

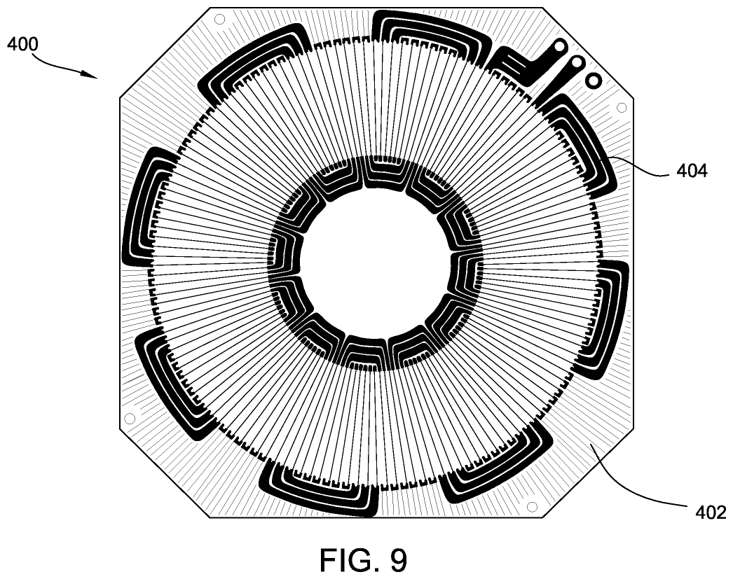

In the example embodiment, stator assembly 24 is a coreless stator assembly. As used herein, the term “coreless stator” means that the stator does not include a magnetic core holding the stator windings or bobbin assembly 86 in place within the motor housing 16. Rather, in the example embodiment, bobbin assembly 86 is directly attached to stator plate 90, which is formed of a non-magnetic, non-conducting material. In particular, in the example embodiment the stator plate 90 is formed of a polymer and/or plastic material, though in alternative embodiments, the stator plate 90 may be formed of any suitable a non-magnetic, non-conducting material. For example, in some alternative embodiments stator plate 90 is formed of a non-ferrous metal such as aluminum. In some embodiments, as described in greater detail with respect to FIG. 9, stator assembly 24 includes a PCB stator 400. As shown in FIG. 6, stator assembly 24 is a multi-phase (more than one phase) axial flux stator, and is preferably a three-phase axial flux stator producing flux in the axial direction (i.e., parallel to axis of rotation 36, shown in FIG. 1).

Bobbin assembly 86 generally includes a plurality of bobbins 87 coupled to a control board 88. Although twelve bobbins 87 are illustrated, bobbin assembly 86 may include any number of bobbins that enables machine 10 to function as described herein. Each bobbin 87 includes an opening 89. In the example embodiment, bobbin assembly 86 also includes electrical winding 97 that includes a plurality of coils 98. In the example embodiment, winding 97 is made up of twelve coils 98 and creates a twelve-pole stator.

In the example embodiment, coils 98 are wound around bobbins 87, and each coil 98 includes two ends, a start and a finish to the coil. Bobbins 87 are coupled electrically coupled to control board 88. In the example embodiment, control board 88 is a printed circuit board (PCB), and each end of each of coil 98 is coupled to control board 88 using an insulation displacement terminal (not shown) designed for directly soldering into control board 88. Alternatively, any other suitable connector may be used that enables the plurality of bobbins 87 to be coupled to control board 88. In the example embodiment, control board 88 includes a wiring connector 128 for directly connecting control board 88 to a motor control board (not shown). In an alternative embodiment, control board 88 is incorporated within a motor control board, thereby eliminating redundant mounting and connectors.

In the example embodiment, stator plate 90 has a disc shape including an outer circumferential edge 92 and an inner rim 94 defining an opening 96. As shown in FIG. 1, the opening 96 is sized to receive second bearing assembly 22 therein to rotatably secure shaft 32 to stator assembly 24. Stator plate 90 further includes a first face 100 and an opposed second face (not shown). In other embodiments, stator plate 90 has any shape that enables stator assembly 24 to function as described herein.

In the example embodiment, bobbins 87 are configured to be coupled to, or more specifically, mounted on stator plate 90. In particular bobbins 87 each include a first end 102 oriented to face rotor assembly 18 (e.g., as shown in FIG. 1) and a second opposed end 104. Coils 98 are coupled to and wrapped around bobbins 87 between first and second ends 102, 104. Bobbins 87 further include mounting posts 106 extending from second end 104. Mounting posts 106 are sized to be received within mounting apertures 108 defined in first face 100 of stator plate 90 and to secure bobbins 87 to stator plate 90. In the example embodiment, each bobbin 87 includes two mounting posts 106 and stator plate 90 defines twenty-four mounting apertures 108, each positioned in correspondence with a respective one of the mounting posts 106. In other embodiments, bobbins 87 may include any suitable number of mounting posts 106 and stator plate 90 may include any suitable number of mounting apertures 108.

In some embodiments, mounting posts 106 are configured to fasten to stator plate 90 by one or more additional fastening elements (not shown), such as a nut, bolt, or other threaded interface between mounting posts 106 and stator plate 90. In other embodiments, mounting posts 106 and or bobbins 87 may be bonded (e.g., via an adhesive or welding) to stator plate 90. In further embodiments, mounting posts 106 are configured for an interference and/or friction fit within mounting apertures 108 to secure bobbins 87 to stator plate 90. For example, and without limitation, in some embodiments, mounting posts 106 may include a wedge tip (not shown) at distal ends of the mounting posts 106 which may engage a slot (not shown) defined within mounting apertures 108. In yet further embodiments, bobbins 87 may be attached to stator plate 90 in any manner that enables electric machine 10 to function as described herein.

The coreless stator assembly 24 in combination with the rotor assembly allows provides a higher level of electrical efficiency compared with conventional stators which include a ferromagnetic core. In particular, the electrical efficiency of a motor is conventionally defined as a ratio of the mechanical power output of the motor to the electrical power input to the motor. Example motors according to the embodiments described herein may have an electrical efficiency that is greater than or equal to 85%, greater than or equal to 90%, or greater than or equal to 95%. The example electrical machine described with respect to FIGS. 1-6 has an electrical efficiency that is about 96-97%.

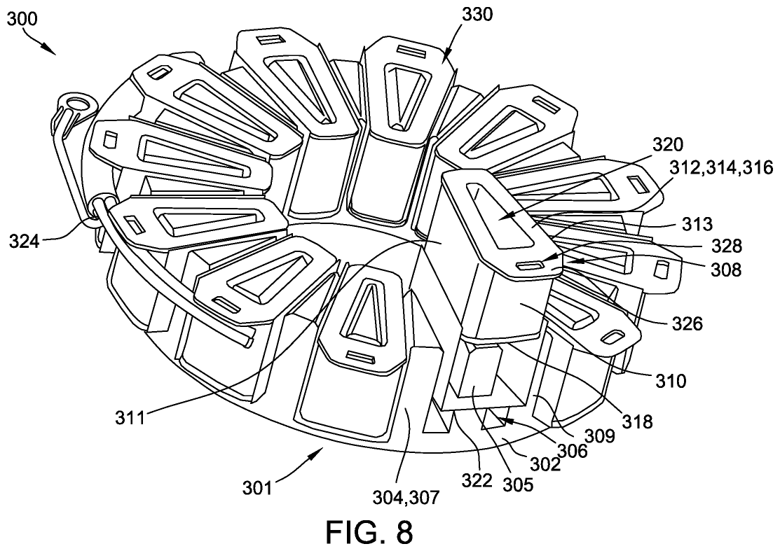

FIG. 8 is a perspective view of an alternative coreless stator assembly 300 for use in the electrical machine 10 shown in FIG. 1. In the example embodiment stator assembly 300 includes a supporting platform 301 that includes an annular body 302 and stator teeth 304 extending axially from annular body 302. In the exemplary embodiment, stator teeth 304 are unitarily formed with annular body 302, though in other embodiments stator teeth 304 may be provided as separate components and attached to annular body 302. Stator teeth 304 are spaced circumferentially about annular body 302 and define slots 306 therebetween. Slots 306 are configured to receive bobbin assemblies 308. Bobbin assemblies 308 and stator teeth 304 collectively define an outer face 330 of stator assembly 300. Stator assembly 300 is configured to be assembled in motor housing 16 (shown in FIG. 1) such that outer surface 330 is oriented to face rotor assembly 18.

In the example embodiment, stator assembly 300 is substantially the same as stator assembly 104 described in U.S. Pat. No. 10,818,427, which is hereby incorporated by reference in its entirety, except as described differently below. In particular, in the example embodiment stator assembly 300 is a coreless stator. In other words, in the example embodiment, body 302 and teeth 304 of stator assembly 300 are formed of a non-magnetic, non-conducting material. In particular, in the exemplary embodiment, body 302 and teeth 304 are formed of a polymer material, though in other embodiments body 302 and teeth 304 may be formed of any suitable non-magnetic, non-conducting material.

Each bobbin assembly 308 includes a conduction coil 310 positioned on a bobbin 312 that is configured to support conduction coil 310. Each bobbin 312 includes a body portion 314 having a first end 316 and a second end 318. Specifically, each conduction coil 310 is wrapped around or coupled about body portion 314 of bobbin 312 between first end 316 and second end 318. Additionally, body portion 314 defines a central opening 320 that receives one stator tooth 304. Bobbins 312 are coupled to every other stator tooth 304 of stator assembly 300 such that conduction coil 310 extends about stator tooth 304 and through slots 306. In particular, each conduction coil 310 extends through slots 306 on each side of the respective stator tooth 304. In the example embodiment, bobbins 312 and conduction coils 310 are positioned on every other stator tooth 304 and between circumferentially adjacent teeth 304. In particular, bobbins 312 are coupled to supporting platform 301 such that a first tooth 305 extends through central opening 320, a second tooth 307 engages a first side 311 of bobbin 312, and a third tooth 309 engages a second opposed side 313 of bobbin 312.

In the example embodiment, stator assembly 300 also includes a plurality of insulation members 322 to insulate components of stator assembly 300, such as annular body 302 and stator teeth 304, from electric current flowing through conduction coil 310. Insulation members 322 are made from a material that is substantially nonconductive. For example, in some embodiments, insulation members 322 are plastic and/or any other material suitable for use as a nonconductive barrier. In some embodiments, at least in part to the body 302 being formed of a non-magnetic, non-conductive material, no insulation members 322 are provided and bobbins 312 are positioned in direct contact with stator teeth 304.

In the example embodiment, each bobbin 312 also includes an extension tab 326 formed on one of first end 316 or second end 318 such that extension tab 326 extends radially beyond a radially inner end or a radially outer end of conduction coil 310. In the example embodiment, extension tab 326 is formed on first end 316 such that extension tab 326 extends beyond radially outer end of conductor coil 112. In such a configuration, extension tab 326 also extends beyond a radially outer end of second end 318. In the example embodiment extension tab 326 extends radially outward a predetermined distance to cover a wire lead 324 of stator assembly 300. More specifically, extension tab 326 extends radially beyond wire lead 324. In the example embodiment, extension tab 326 includes an opening 328 defined therethrough. Opening 328 is substantially radially aligned with central opening 320 of body portion 314 and is positioned radially outward of conductor coil 112. In the example embodiment, opening 328 is configured to receive a lead tie (not shown) of stator assembly 300 to secure wire lead 324 to bobbin 312.

FIG. 9 is a perspective view of an alternative coreless stator assembly 400 for use in the electrical machine 10 shown in FIG. 1. In the example embodiment, stator assembly 400 is a PCB stator including a non-conductive substrate 402 and a plurality of winding layers 404 etched into the substrate 402. In the example embodiment the winding layers 404 are copper traces, though in other embodiments any suitable conducting material may be used.

Described herein are example methods and systems for axial flux machines. The axial flux machines include a rotor having axially embedded permanent magnets and a coreless stator. The coreless stator allows for improved efficiency of the axial flux machine by reducing and/or eliminating core loss in the stator. The axially embedded rotor design enables the use of lower-cost ferrite magnets with the coreless stator, while achieving the power densities and higher efficiency of other rotor designs that use higher-cost neodymium magnets.

Example embodiments of the axial flux electric machine assembly are described above in detail. The electric machine and its components are not limited to the specific embodiments described herein, but rather, components of the systems may be utilized independently and separately from other components described herein. For example, the components may also be used in combination with other machine systems, methods, and apparatuses, and are not limited to practice with only the systems and apparatus as described herein. Rather, the example embodiments can be implemented and utilized in connection with many other applications.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An axial flux motor comprising:
a housing;
a rotor assembly rotatably secured to said housing, said rotor assembly comprising:
a body defining an axis of rotation thereof, said body having first and second opposed faces;
a plurality of rotor poles including a first rotor pole and a second rotor pole, said first rotor pole and said second rotor pole cooperatively defining an axially extending pocket circumferentially therebetween; and
a plurality of spaced apart magnets extending from said first face, a first magnet of said plurality of magnets being positioned within the axially extending pocket; and
a coreless stator assembly fixedly secured to said housing, said coreless stator assembly comprising a supporting platform and a plurality of coils attached on said supporting platform.

2. The axial flux motor of claim 1, wherein said coreless stator assembly further comprises a bobbin assembly comprising a plurality of bobbins holding said plurality of coils, said supporting platform defining a plurality of mounting apertures, wherein a first bobbin of said plurality of bobbins comprises a mounting post extending from said first bobbin into a first aperture of said plurality of mounting apertures to secure said first bobbin to said supporting platform.

3. The axial flux motor of claim 2, wherein said supporting platform comprises a first planar face oriented to face said rotor assembly and a second, opposed planar face, and wherein said plurality of mounting apertures are defined within said first planar face.

4. The axial flux motor of claim 2, wherein said first bobbin comprises a first end oriented to face said rotor assembly, and a second opposed end, wherein a first coil of said plurality of coils is coupled to said first bobbin between said first and second ends, and wherein said mounting post extends axially from said second end of said first bobbin.

5. The axial flux motor of claim 1, wherein at least one of said magnets has a minimum axial depth defined by,
$${D}_{min} = \frac{Φ}{2 * N * R * Br} ,$$
wherein Φ represents a flux output of said rotor assembly, N represents a number of said rotor poles, Dₘᵢₙ represents the minimum axial depth of said at least one magnet, R represents a radial length of said magnet, and Br represents a remnant flux density of said at least one magnet.

6. The axial flux motor of claim 1, wherein at least one of said poles has a trapezoidal shape and at least one of said magnets has a rectangular shape.

7. The axial flux motor of claim 1, wherein at least one of said poles has a rectangular shape and at least one of said magnets has a trapezoidal shape.

8. The axial flux motor of claim 1, wherein said coreless stator assembly further comprises a first bobbin extending axially between a first end and a second opposed end, said first bobbin holding a first coil of said plurality of coils between said first end and said second end, said first bobbin defining a central opening extending through said first end and said second end.

9. The axial flux motor of claim 8, wherein said supporting platform comprises an annular polymer body and a plurality of circumferentially spaced polymer teeth extending axially from said body, and wherein a first tooth of said plurality of teeth extends through a central opening defined in a first bobbin.

10. The axial flux motor of claim 9, wherein a second tooth of said plurality of teeth is positioned to engage a first side of said first bobbin and a third tooth of said plurality of teeth is positioned to engage a second, opposed side of said first bobbin, wherein said first tooth is positioned circumferentially between said second tooth and said third tooth.

11. The axial flux motor of claim 1, wherein said coreless stator assembly is a printed circuit board stator.

12. An axial flux motor comprising:
a housing;
a rotor rotatably secured to said housing, said rotor comprising a body defining an axis of rotation thereof, said body having first and second opposed faces, said rotor further comprising a plurality of rotor poles including a first rotor pole and a second rotor pole;
a plurality of spaced apart magnets extending from said first face, a first magnet of said plurality of magnets being positioned circumferentially between, and in contact with, said first rotor pole and said second rotor pole; and
a stator fixedly secured to said housing, said stator comprising a supporting platform and a plurality of coils attached on said supporting platform, said supporting platform being formed of a non-magnetic material.

13. The axial flux motor of claim 12, wherein said stator further comprises a bobbin assembly comprising a plurality of bobbins holding said plurality of coils, said supporting platform defining a plurality of mounting apertures, wherein a first bobbin of said plurality of bobbins comprises a mounting post extending from said first bobbin into a first aperture of said plurality of mounting apertures to secure said first bobbin to said supporting platform.

14. The axial flux motor of claim 13, wherein said supporting platform comprises a first planar face oriented to face said rotor and a second, opposed planar face, and wherein said plurality of mounting apertures are defined within said first planar face.

15. The axial flux motor of claim 13, wherein said first bobbin comprises a first end oriented to face said rotor, and a second opposed end, wherein a first coil of said plurality of coils is coupled to said first bobbin between said first and second ends, and wherein said mounting post extends axially from said second end of said first bobbin.

16. The axial flux motor of claim 12, wherein at least one of said magnets has a minimum axial depth defined by,
$${D}_{min} = \frac{Φ}{2 * N * R * Br} ,$$
wherein Φ represents a flux output of said rotor, N represents a number of said rotor poles, Dₘᵢₙ represents an axial depth of said at least one magnet, R represents a radial length of said at least one magnet, and Br represents a remnant flux density of said magnet.

17. The axial flux motor of claim 12, wherein said stator further comprises a first bobbin extending axially between a first end and a second opposed end, said first bobbin holding a first coil of said plurality of coils between said first end and said second end, said first bobbin defining a central opening extending through said first end and said second end.

18. The axial flux motor of claim 17, wherein said supporting platform comprises an annular polymer body and a plurality of circumferentially spaced polymer teeth extending axially from said body, and wherein a first tooth of said plurality of teeth extends through a central opening defined in said first bobbin.

19. The axial flux motor of claim 18, wherein a second tooth of said plurality of teeth is positioned to engage a first side of said first bobbin and a third tooth of said plurality of teeth is positioned to engage a second, opposed side of said first bobbin, wherein said first tooth is positioned circumferentially between said second tooth and said third tooth.

20. An axial flux motor comprising:
a housing;
a rotor assembly rotatably secured to said housing, said rotor assembly comprising a body defining an axis of rotation thereof, said body having first and second opposed faces, said rotor assembly further comprising a plurality of rotor poles including a first rotor pole and a second rotor pole;
a plurality of spaced apart magnets extending from said first face, a first magnet of said plurality of magnets being positioned circumferentially between said first rotor pole and said second rotor pole; and
a coreless stator assembly fixedly secured to said housing, said coreless stator assembly comprising a supporting platform defining a mounting aperture and a bobbin assembly comprising an electrical winding and a bobbin holding said electrical winding, said bobbin assembly further comprising a mounting post extending from said bobbin into the mounting aperture to secure said bobbin assembly to said supporting platform.
